(19) United States
(12) Patent Application Publication
(10) Pub. No.: US 2011/0058492 A1
(43) Pub. Date: Mar. 10, 2011

(54) MANAGING RESOURCES IN A WIRELESS COMMUNICATION SYSTEM COMPRISING AT LEAST ONE SCHEDULING CHANNEL

(75) Inventor: Per Ernström, Stockholm (SE)

(73) Assignee: TELIA-SONERA AB, Stockholm (SE)

(21) Appl. No.: 12/674,777

(22) PCT Filed: Aug. 1, 2008
(86) PCT No.: PCT/SE2008/000466

§ 371 Date: Oct. 13, 2010

(30) Foreign Application Priority Data
Aug. 24, 2007 (SE) 0701937-5

(51) Int. Cl. H04W 72/04; H04W 24/00

(52) U.S. Cl. 370/252; 370/329

(57) ABSTRACT

A wireless communication system for managing resources and a method for managing resources in a wireless communication system, which system comprises at least one base station (102) and at least one mobile station (104), the base station (102) being assigned with a number of carriers (106, 108, 110) deployed in parallel, by means of which carriers (106, 108, 110) the base station (102) and the mobile station (104) are adapted to communicate with each other. Uplink and downlink resources are scheduled on said number of carriers (106, 108, 110), a scheduling channel is assigned to at least one of the carriers (106, 108, 110), and scheduling information is transmitted to the mobile station (104) on the scheduling channel assigned to one of the carriers (106, 108, 110).

### TECHNICAL FIELD

The present invention relates to a wireless communication system of the kind defined in the preamble of claim 1, and to a method for managing resources in a wireless communication system of the kind defined in the preamble of claim 11.

### BACKGROUND OF THE INVENTION

In general, a mobile communication system provides services to a plurality of mobile stations using a scheduling method.

The services include voice and data communication services. The term “scheduling” refers to a process of granting a right to channel resources during a certain time period to a particular mobile station among a plurality of mobile stations according to channel conditions, traffic load, priorities, or other factors, and determining these channel resources, e.g. in the form of data rates, allocated to the mobile stations. The grants given are valid for a certain time period, where after new grants are given based on updated channel conditions, traffic load etc.

For scheduling of uplink resources it is necessary for the mobile station to signal information such as radio channel quality and load to the base station as a basis for the scheduling decisions to be made by the base station, and for the base station to signal what grants have been given to the mobile station by the scheduling process.

For scheduling of downlink resources it is necessary for the base station to signal to the mobile station which part of the common resources that have been scheduled for the mobile station and thus should be received and processed by the mobile station.

We will here refer to the signalling of uplink grants and of scheduled downlink channel resources as signalling of scheduling information.

Since scheduling requires some overhead e.g. in terms of signalling of measured channel conditions, allocated uplink grants, etc, scheduling is most efficient for high data rate services for which the signalling overhead is small compared to the user data transferred. In fact, for low data rate voice services it may be as efficient or even more efficient to grant fixed resources valid until they are changed or closed through explicit signalling, as was normally the case in early multiple access systems designed mainly for low rate voice services.

In general, a mobile communication system comprises several base stations which serve several mobile stations. The base station is assigned with one or more carrier by means of which the base station and the mobile station communicate with each other.

In a mobile communication system, the trunking efficiency is good if the bitrate of the end-user service is considerably smaller than the total capacity of the shared resources. Many new services, such as WEB-browsing, video-streaming, video-telephony, require large bitrates, and thus a large shared resource is required to achieve a good trunking efficiency.

One 5 MHz WCDMA carrier is not considered to be a large enough resource to achieve good trunking efficiency for services requiring large bitrates. When deploying several 5 MHz WCDMA carriers in parallel, one would therefore like to combine them into one shared, or common, resource. For constant bitrate services, this can be achieved through load based inter frequency handover. For quickly varying traffic, such as bursty WEB-browsing traffic, the handover mechanism is however neither fast nor efficient enough. Another solution could be a so called multi-carrier system, MCS, where data is sent simultaneously over several parallel deployed carriers. However, a special mobile station is required for a MSC in order to receive and transmit simultaneously on several carriers, and the provision of these mobile stations has been found to be complex. CDMA2000 3× is an example of a multi-carrier standard.

### THE OBJECT OF THE INVENTION

The object of the present invention is thus to improve the trunking efficiency in a wireless communication system without requiring the provision of complex mobile stations.

### SUMMARY OF THE INVENTION

The above-mentioned object is achieved by providing a wireless communication system of the kind defined in the introductory part, which comprises the features which are mentioned in the characterizing portion of claim 1, and by providing a method of the kind defined in the introductory part, which comprises the features which are mentioned in the characterizing portion of claim 11.

By the common scheduling of the resources on all of the parallel carriers according to the present invention, the trunking efficiency is radically improved in relation to conventional wireless communication systems in use today, without the need of introducing the complexity of a full multi-carrier system.

The invention can also be seen as an evolutionary step towards a multi-carrier system which may be implemented in a future when the technical development has made the complexity of a multi-carrier system acceptable.

According to an advantageous embodiment of the system according to the present invention, scheduling information is signalled only on one specific carrier, referred to as the base carrier. The scheduling information signalled on the base carrier controls the radio resources on all carriers. The other downlink carriers in parallel with the base carrier are hereinafter also called co-carriers. The base carrier can be predetermined.

According to a further advantageous embodiment of the system according to the present invention, scheduling information is signalled on two or more of the carriers. The scheduling information signalled on any of these carriers controls radio resources on all carriers, and the system comprises co-ordination means for coordinating the scheduling information on the carriers so that the same resource is scheduled only once.

According to advantageous embodiments of the system according to the present invention, the system comprises transmission means for transmitting a pilot signal, for channel measurement, and/or system information and/or a synchronisation signal from the base station to the mobile station, said transmission means being adapted to transmit the synchronisation signal and/or the synchronisation signal and/or the pilot signal on the base carrier only.

Common channels like e.g. the system information broadcast, the synchronisation channel, pilot channel, and scheduling information control channel, require a substantial part of the WCDMA capacity. These embodiments enable the removal of some or all of these common channels on all but one of the parallel deployed carriers, freeing capacity for end-user traffic. Hereby overhead from e.g. system information broadcast, control, pilot and synchronisation channels, is reduced.

The system information may contain, e.g., neighbour cell information, own cell information, higher layer information like PLMN code or similar operator identities, etc. With regard to the synchronisation signal and in the CDMA case, a non orthogonal code may be used to allow fast cell-search and synchronisation.

By not transmitting a pilot signal on the co-carrier, and no, or limited, measurements are performed on the co-carriers, resources are saved and the complexity of the mobile stations and the system is reduced. In this case, scheduling and selection of coding and modulation is based on the measurements on the base carrier.

By transmitting a pilot signal on the co-carriers some resources are used for the pilot signals, but better measurements can be performed on the co-carriers, allowing scheduling based on good channel quality measurements on all separate carriers.

According to another advantageous embodiment of the system according to the present invention, the mobile station is provided with a dual receiver capability allowing reception of scheduling information on a first downlink carrier simultaneously as user data is received on a second downlink carrier and/or on said first downlink carrier.

Further, the dual receiver capability enables reception of scheduling information on the base-carrier simultaneously as end-user traffic is received on one of the other carriers and/or on the base-carrier. Further, this embodiment enables reception of scheduling information and end-user data on the base-carrier, simultaneously as measurements are performed on one of the other carriers.

The dual receiver capability can also be used to allow inter frequency measurements on a carrier which is not one of the parallel carriers scheduled from the base carrier, it may for example be a standalone carrier or it may be part of a different set of parallel carriers scheduled from a different base carrier, while still receiving scheduling information and possibly also user data on the base carrier. Thus, inter frequency handover can be improved.

Measurement opportunities for a certain mobile station may thus be provided by the scheduler, either by not scheduling any downlink resources for that mobile station during a certain timeslot, or by scheduling downlink resources during a certain timeslot only on the base carrier or on the carrier to be measured.

According to advantageous embodiments of the method according to the present invention, system information and/or a synchronisation signal and/or a pilot signal are/is transmitted from the base station to the mobile station, on the base carrier only, whereby overhead from, e.g., system information broadcast, control, pilot and synchronisation channels, is reduced.

According to another advantageous embodiment of the method according to the present invention, the mobile station is provided with a dual receiver capability allowing reception of scheduling information on a first downlink carrier simultaneously as user data is received on a second downlink carrier and/or on said first downlink carrier.

Further advantageous embodiments of the method and the system, respectively, according to the present invention, emerge from the enclosed dependent claims and the detailed description of preferred embodiments.

### BRIEF DESCRIPTION OF THE DRAWINGS

The present invention will now be described, for exemplary purposes, in more detail by way of embodiments and with reference to the enclosed drawings, in which:

FIG. 1 is a schematic block diagram illustrating aspects of the wireless communication system and the method according to the present invention.

### DETAILED DESCRIPTION OF PREFERRED EMBODIMENTS

### Abbreviations

3GPP 3rd Generation Partnership Project
CDMA Code Division Multiple Access
CQI Channel Quality Indications
DL Downlink
FDD Frequency Division Duplex
HSPA High-Speed Packet Access
MCS Multi-Carrier System
PLMN Public Land Mobile Network
UL Uplink
UMTS Universal Mobile Telecommunications System
WCDMA Wideband Code Division Multiple Access

The embodiments are exemplified by WCDMA, but the present invention is also applicable to other radio access technologies.

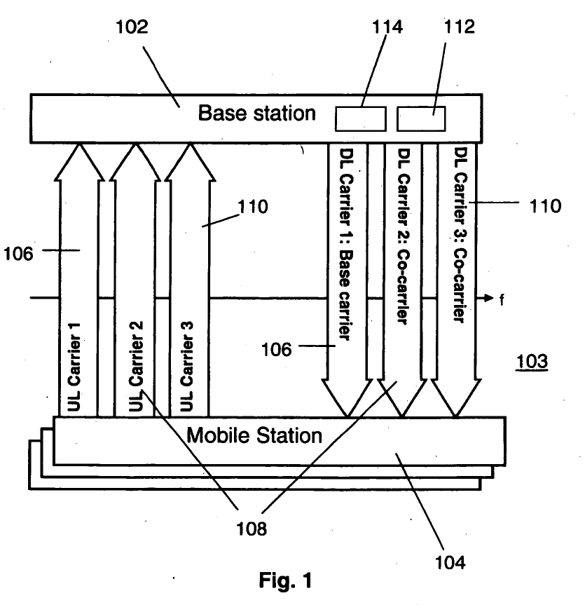

In FIG. 1, a wireless communication system for managing resources is schematically disclosed. According to a first aspect of the system according to the present invention, the system comprises at least one base station 102 belonging to a cell 103 of a cellular network, and at least one mobile station 104, or mobile terminal. The base station 102 is assigned with three FDD carriers 106, 108, 110 deployed in parallel, by means of which carriers 106, 108, 110, the base station 102 and the mobile station 104 are adapted to communicate with each other. In FIG. 1, the carriers 106, 108, 110 are illustrated both in downlink, DL, and uplink, UP. In downlink, one of the carriers 106, 108, 110 is defined as the base carrier 106 and the other two carriers 108, 110 are defined as co-carriers. Typically, the carriers 106, 108, 110 are co-sited and adjacent in frequency. However, the carriers could also be arranged in another way, e.g. not co-sited and non-adjacent in frequency.

According to the first aspect, the mobile station 104 is adapted to receive simultaneously on two of the carriers 106, 108, 110, i.e. two downlink carriers. Mobile stations 104 adapted to receive simultaneously on more than two carriers may also be used, which however would require this enhanced capability to be signalled to the network to allow the scheduler to make use of the enhanced capability. Further, according to the first aspect, the mobile station 104 is adapted to transmit on only one of the carriers 106, 108, 110, i.e. one uplink carrier. The mobile station 104 is adapted to transmit on any one of the carriers 106, 108, 110, irrespective of on which carriers 106, 108, 110 the mobile station 104 is receiving. As a basis for the scheduler, the mobile station 104 is adapted to transmit Channel Quality Indications, CQI, based on measurements, to the base station 102. When the mobile station. 104 transmits user data, the mobile station 104 is adapted to transmit CQI, other control signalling, and the user data on the same uplink carrier 106, 108, 110. When no user data is transmitted, CQI and other control signalling are transmitted on a default carrier allocated by the base station 102. Mobile stations adapted to transmit simultaneously on more than one carrier can be used, which however would require this enhanced capability to be signalled to the network to allow the scheduler to make use of the enhanced capability.

According to the first aspect of the system according to the present invention, the base station 102 includes schedule means 112 for scheduling uplink and downlink resources on said number of carriers, only the base carrier 106 is assigned with a scheduling channel, or two or more scheduling sub-channels, and the base station 102 includes transmission means 114 for transmitting scheduling information to the mobile station 104 on the scheduling channel, or said two or more scheduling sub-channels, assigned to the base carrier 106. The transmission means 114 are adapted to transmit scheduling information to the mobile station 104 on this base carrier only.

The base station 102 is adapted to transmit scheduling information on the base carrier 106 with information on what uplink and downlink resources, i.e. carrier, CDMA code, uplink power, modulation, coding, space, time, frequency etc, are allocated to the mobile station 104 in an upcoming timeslot. The scheduling information can be code and/or time and/or branch multiplexed with user data, pilot channel etc.

The scheduler allocates downlink resources to the mobile station on a maximum of two downlink carriers 106, 108, 110 and uplink resources on a maximum of one uplink carrier 106, 108, 110. When the mobile station 104 is transmitting user data, the mobile station 104 transmits CQI on the same uplink channel 106, 108, 110. When the mobile station 104 is not transmitting user data the mobile station 104 transmits CQI on an allocated default uplink carrier 106, 108, 110.

Further, said transmission means 114 are adapted to transmit, a pilot signal for channel measurement, system information, and a synchronisation signal from the base station to the mobile station on the base carrier 106 only. The schedule means 112 are adapted to schedule said resources based on Channel Quality Indications, CQI, received from the mobile station 104. The mobile station 104 is provided with a dual receiver capability allowing reception of scheduling information on a first downlink carrier 106, 108, 110 simultaneously as user data is received on a second downlink carrier 106, 108, 110 and/or on said first downlink carrier 106, 108, 110.

With reference to the wireless communication system of FIG. 1 and according to a fist aspect of the method for managing resources in a wireless communication system according to the present invention, the method includes the following steps: A scheduling channel is assigned to the base carrier 106 only. Uplink and downlink resources are scheduled on all three carriers 106, 108, 110 by the base station 102. Scheduling information is transmitted to the mobile station 104 on the scheduling channel assigned to the base carrier 106. The base station 102 transmits a pilot signal for channel measurement, system information, and a synchronisation signal to the mobile station 104, on the base carrier 106 only. The mobile station 104 transmits Channel Quality Indications, CQI, to the base station 102, and the base station 102 schedules the resources based on the CQI.

According to other aspects of the present invention, to allow carrier specific channel measurements a pilot signal, i.e. a signal known by the mobile station, can be transmitted on each carrier. Measurement results can be signalled to the network and the common resources can be scheduled and the appropriate modulation, coding, and output power can be selected in an optimal way based on the carrier specific radio channel and/or interference estimates, combined with other information such as load and buffer status, Quality of Service, QoS, requirements etc. The interference produced by the pilot signal may be reduced by the use of orthogonal codes (the CDMA case) and/or time multiplexing with user data. If the invention is implemented as an enhancement of an already deployed technology one or more of the parallel carriers may be equipped with all required common channels etc, to allow legacy mobile stations to camp on and utilize the given carrier. As the legacy mobile station fleet is phased out, the number of carriers supporting legacy mobile stations may be reduced to enhance capacity.

One possibility is to allow legacy mobile stations only on the base carrier which has to support system information broadcast, scheduling channel, etc. Further, certain resources in terms of e.g. codes and or power may be reserved to support legacy mobile stations. In the specific example of WCDMA, this may be necessary to support dedicated channels, while common channels such as HSPA channels, e.g., could preferably be shared between legacy mobile stations and new mobile stations.

According to still other aspects of the present inventions, various alternatives of mobile stations (terminals or communication devices) are possible. The mobile station can be adapted to transmit only a carrier paired with a fixed duplex distance to one of the carriers which the mobile station is currently receiving on. The scheduler is responsible to take this restriction into account. This alternative implementation is applicable to the FDD case.

The mobile station can also be adapted to receive on one carrier only. Scheduling information is time-multiplexed with downlink user-data to allow scheduling of co-carrier resources without having dual receiver capability. Further, the mobile station can also be adapted to receive on three carriers to allow simultaneous reception of scheduling information, reception of user data, and performing measurement, simultaneously on three different carriers.

To the invention is applicable to 3G, 3GPP, and services and products based on WCDMA (3G/UMTS/HSPA) networks.

To implement the present invention for WCDMA/HSPA, the following changes in the standard should preferably be made: Enhancement of HSPA scheduling channels or introduction of supplementing scheduling channels to indicate on which carrier/carriers resources are scheduled; Enhancement of CQI-reporting to report CQI for all carriers; New requirements on mobile station measurements on co-carriers, e.g., for CQI-reporting purposes; Introduction of a new mobile station class, with capabilities as described above.

1. A wireless communication system for managing resources, comprising:
at least one base station and at least one mobile station, the base station being assigned with a number of carriers deployed in parallel, by means of which carriers the base station and the mobile station are adapted to communicate with each other,
schedule means for scheduling uplink and downlink resources on said number of carriers, at least one of the carriers being assigned with a scheduling channel, or two or more scheduling sub-channels, and
transmission means for transmitting scheduling information to the mobile station on the scheduling channel, or said two or more scheduling sub-channels, assigned to one of the carriers.

2. The wireless communication system according to claim 1,
wherein two or more of the carriers are assigned with a scheduling channel, or two or more scheduling sub-channels, and
wherein the system comprises coordination means for coordinating the scheduling information on the carriers so that the same recourse is scheduled only once.

3. The wireless communication system according to claim 1,
wherein only one specific carrier, a base carrier, is assigned with a scheduling channel, or scheduling sub-channels, and
wherein the transmission means are adapted to transmit scheduling information to the mobile station on this base carrier only.

4. The wireless communication system according to claim 3, comprising transmission means for transmitting system information from the base station to the mobile station, said transmission means being adapted to transmit system information on the base carrier only.

5. The wireless communication system according to claim 3 comprising transmission means for transmitting a synchronisation signal from the base station to the mobile station, said transmission means being adapted to transmit the synchronisation signal on the base carrier only.

6. The wireless communication system according to claim 3, comprising transmission means for transmitting a pilot signal, from the base station to the mobile station, for channel measurement, said transmission means being adapted to transmit the pilot signal on the base carrier only.

7. The wireless communication system according to claim 1, wherein the schedule means are adapted to schedule said resources based on Channel Quality Indications, CQI, which are based on measurements.

8. The wireless communication system according to claim 7, wherein the mobile station is adapted to transmit CQI to the base station.

9. The wireless communication system according to claim 8, wherein when the mobile station is transmitting user data, the mobile station is adapted to transmit the user data and CQI on the same uplink carrier.

10. The wireless communication system according to claim 1, wherein the mobile station is provided with a dual receiver capability allowing reception of scheduling information on a first downlink carrier simultaneously as user data is received on a second downlink carrier and/or on said first downlink carrier.

11. A method for managing resources in a wireless communication system, the system comprising at least one base station and at least one mobile station, the base station being assigned with a number of carriers deployed in parallel, by means of which carriers the base station and the mobile station are communicating with each other, the method comprising:
scheduling uplink and downlink resources on said number of carriers, by assigning a scheduling channel, or two or more scheduling sub-channels, to at least one of the carriers, and
transmitting scheduling information to the mobile station on the scheduling channel, or said two or more scheduling sub-channels, assigned to one of the carriers.

12. The method according to claim 11, comprising:
assigning two or more of the carriers with a scheduling channel, or two or more scheduling sub-channels, and
coordinating the scheduling information on the carriers so that the same recourse is scheduled only once.

13. The method according to claim 11, comprising assigning a scheduling channel, or scheduling sub-channels, to one specific carrier only, a base carrier, whereupon the scheduling information is transmitted to the mobile station on this base carrier only.

14. The method according to claim 13, comprising transmitting system information, from the base station to the mobile station, on the base carrier only.

15. The method according to claim 13, comprising transmitting a synchronisation signal, from the base station to the mobile station, on the base carrier only.

16. The method according to claim 13, comprising transmitting a pilot signal, from the base station to the mobile station, on the base carrier only, for channel measurement.

17. The method according to claim 12, comprising scheduling said resources based on Channel Quality Indications, CQI, which are based on measurements.

18. The method according to claim 17, wherein CQI are transmitted to the base station by the mobile station.

19. The method according to claim 18, wherein when the mobile station is transmitting user data on an uplink carrier, the mobile station transmits CQI on the same uplink carrier.

20. The method according to claim 12, comprising providing the mobile station with a dual receiver capability allowing reception of scheduling information on a first downlink carrier simultaneously as user data is received on a second downlink carrier and/or on said first downlink carrier.

21. The method according to claim 12, wherein scheduling information is transmitted to the mobile station from and by the base station.
